(19) United States
(12) Patent Application Publication
(10) Pub. No.: US 2026/0138411 A1
(43) Pub. Date: May 21, 2026

(54) METHOD FOR MONITORING THE WEAR OF AN AIR SUSPENSION FOR MOTOR VEHICLES

(71) Applicant: ZF CV Systems Global GmbH, Bern (CH)

(72) Inventor: Santhosh Bakthavatchalam, Langenhagen (DE)

(21) Appl. No.: 19/441,615

(22) Filed: Jan. 6, 2026

Related U.S. Application Data
(63) Continuation of application No. PCT/EP2024/068167, filed on Jun. 27, 2024.

(30) Foreign Application Priority Data
Jul. 19, 2023 (IN) 202311048495

(51) Int. Cl. B60G 17/0185

(52) U.S. Cl. CPC B60G 17/0185; B60G 2202/152; B60G 2400/252; B60G 2600/08

(57) ABSTRACT

A method is for monitoring the wear of an air suspension for motor vehicles. A filling volume of a spring bellows determines a level position of an air spring and the level position is continuously detected by a height sensor. The level position detected by the height sensor is compared with a predetermined upper level position value for a high level position and a predetermined lower level position value for a low level position. Instances of level attainment, when the detected level position exceeds the upper level position value or the detected level position falls below the lower level position value are counted. From the count of the instances of level attainment, a wear status of the air suspension is concluded.

### CROSS-REFERENCE TO RELATED APPLICATIONS

This application is a continuation application of international patent application PCT/EP2024/068167, filed June 27, 2024, designating the United States and claiming priority from Indian application 202311048495, filed July 19, 2023, and the entire content of both applications is incorporated herein by reference.

### TECHNICAL FIELD

The disclosure relates to a method for monitoring wear of an air suspension for motor vehicles, especially commercial vehicles.

### BACKGROUND

The suspension is part of the chassis of vehicles, where the vehicle may be a truck or a trailer and especially a commercial vehicle. The suspension supports a weight of a vehicle body and a vehicle load and ensures that excitations from a road are not transmitted directly to the vehicle body. In doing so, the suspension provides a compromise between driving comfort and driving safety. Air suspension uses the compressibility of air, which is enclosed in a spring bellows of an air spring. The air spring is supplied with compressed air by a compressor or, in the case of trucks in particular, compressed air is branched off from a pneumatic brake system of the motor vehicle. Depending on the vehicle load, air is pumped in or out to adjust the filling volume of the spring bellows and thus the level position of the vehicle. The level position is detected via a height sensor, so that the attainment of an intended level position can be recognized. Furthermore, the level can be kept constant with the help of the height sensor.

The air suspension is a system that is constantly under load when the vehicle is in operation and wears out as the operating time progresses. Failure of the air suspension due to wear can be avoided if the worn air spring is serviced or replaced in good time.

### SUMMARY

The present disclosure is based on the object of monitoring the wear of an air suspension with little effort and at low cost.

According to the disclosure, this task is solved by various methods according to the disclosure.

According to the disclosure, the level position continuously detected by the height sensor is compared with a predetermined upper level position value for a high level position and a predetermined lower level position value for a low level position. The two level values are determined in advance and specified for monitoring. Instances of level attainment are counted, that is, a count is made if the detected level exceeds the upper level or if the detected level falls below the lower level. A current wear status, that is, current progress of the wear, of the air suspension is concluded from the count of instances of level attainments, that is, in particular the number instances of level attainments. The monitoring of the wear uses existing means of the air suspension, namely in particular the height sensor, and observes its movements according to the load of the air suspension and the filling volumes of the spring bellows. The monitoring of wear can be carried out with little effort in the background of the level control, whereby the counts are carried out for the purpose of detecting advanced wear.

In an embodiment of the disclosure, the level position detected by the height sensor is also compared with a predefined average value for a neutral level position and the instances of exceeding the neutral level position are counted. From the count of the instances of exceeding the neutral level position, conclusions can be drawn about the current wear of the air suspension, so that the monitoring of the wear of the air suspension is refined by observing the movement of the height sensor.

With little effort, the progress towards reaching the critical wear status can be determined from the comparison of the current count of instances of level attainment and/or the current count of instances of exceeding the neutral level position with a service life value (lifetime value) or a predetermined proportion. In other words, taking into account the current number of times the upper level position and the lower level position have been reached and the distance of the count from the predetermined threshold (service life value or proportion thereof), the current progress of wear is estimated. The progress of wear is determined by comparing the current number of times the level has been reached or the current number of times the neutral level has been exceeded with a comparative measure. In a preferred embodiment, this is the respective service life value or the specified proportion of the service life value. This information about current wear can also be provided for maintenance purposes or even to the driver of the vehicle with little effort.

### BRIEF DESCRIPTION OF DRAWINGS

The invention will now be described with reference to the drawings wherein:

FIG. 1 is a pneumatic and electrical diagram of an air suspension; and,

FIG. 2 is a flow chart of an example of a method for monitoring the wear of an air suspension according to FIG. 1 .

### DETAILED DESCRIPTION

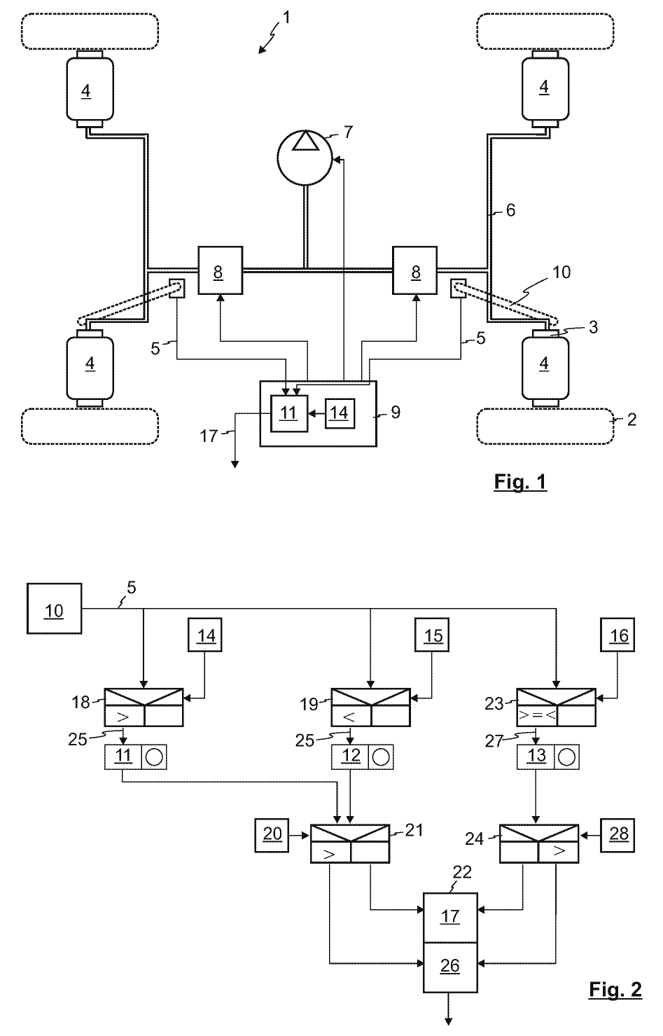

FIG. 1 shows a pneumatic and electrical diagram of an air suspension 1 of a vehicle, which here is realized as a truck. In the example shown, an air spring 3 is assigned to each wheel 2 of the vehicle. Each air spring 3 includes a spring bellows 4 which can be filled with air and a filling volume of which determines a level position 5 of the respective air spring 3. The spring bellows 4 of several air springs 3 are connected to a common compressed air source 7 via supply lines 6, so that a common level position of the air suspension 1 is established at all connected air springs 3. The compressed air source 7 is the vehicle's pneumatic brake system (not shown), from which compressed air is branched off or taken as required. Alternatively, a compressed air source 7 of the air suspension system 1 can be a compressor.

The compressed air supply to the spring bellows 4 of the air suspension 1 is determined by valve blocks 8, which are controlled by a control unit 9. The control unit 9 is also configured to set the filling volume of the spring bellows 4 and to activate the compressed air source 7 when air is required, that is, to open the connection to the vehicle's brake system or, in the case of a compressor, to start the compressor.

The current level 5 is detected via a height sensor 10, the measured value of which is provided to the control unit 9 with information about the level. With knowledge of the current level position 5, the control unit 9 is able to detect whether an intended level position has been reached. If the intended level 5 has not yet been reached, the control unit 9 ensures that further compressed air is supplied and the filling volume of the spring bellows 4 is increased by activating the valve block 8 and the compressed air source 7. The control unit 9 is also configured to regulate the level 5 and to keep the filling volume constant.

To monitor the wear of the air suspension 1, the information available from the height sensor 10 about the level position 5 is used and counts 11, 12, 13 are carried out of the events when the level position 5 reaches predetermined level position values 14, 15, 16. In the example embodiment shown, the monitoring of the wear is performed by the control unit 9, which determines a wear status 17. The wear status 17 can be called up by the control unit 9 if required. If the determination of the wear status 17 shows that the wear is already far advanced, a need for maintenance or replacement can be indicated by actively communicating the wear status 17.

The monitoring of wear is described below with reference to FIG. 2. The same reference signs as in FIG. 1 are used for the same elements. To monitor the wear, the level 5 detected by the height sensor 10 is monitored using specified level values and conclusions are drawn about the current wear status 17. An upper level value 14 is specified for a high level position 5 and a lower level value 15 for a low level position 5. If a comparison 18 of the detected level position 5 with the specified upper level value 14 shows that the level 5 reaches this upper threshold or exceeds the upper level value 14, this level attainment 25 is counted. Likewise, a comparison 19 of the detected level position 5 with the lower level value 15 and a count 12 of the level attainment 15 takes place if the detected level 5 falls below the lower level value 15.

From the counts 11, 12 of the instances of level attainment 25, progress of the wear of the air suspension and the current wear status 17 is concluded by comparing the current count 11, 12 with a service life value 20 (reference sign 21). The service life value 20 is predetermined on the basis of the specific characteristics of the model of the operated air spring 3 and bellows 4 and is estimated on the basis of information from the manufacturer of the air spring 3. From the comparison 21 of the count 11, 12 of the instances of level attainment 25 with the service life value 20, the current wear status 17 can be concluded by evaluating 22 this information. On the one hand, it is directly recognizable whether the count 11, 12 reaches or exceeds the predetermined threshold of the service life value 20. In this case, the evaluation 22 indicates a critical wear status 26 and a need for maintenance of the air spring 3 or its replacement. On the other hand, wear is also monitored until the service life value 20 is reached. In this case, a distance to the service life value is determined from the comparison 21 of the count 11, 12 of the instances of level attainment with the service life value 20 and thus information on the remaining service life of the air spring 3. As part of the evaluation of the comparison 22, information on the wear status 17 can be made available for retrieval from the result of the comparison 21 of the count 11, 12 of the instances of level attainment with the service life value 20.

The specified service life value 20 can correspond to the service life of the air springs 3 and its bellows 4 estimated by the manufacturer or to a proportion of the total service life. Advantageously, a proportion of 50 % to 75 % of the service life of the air spring 3 or its bellows 4 is specified as the service life value for monitoring the wear of the air suspension 1, so that a wear warning can be given in good time before the service life is reached and fatal damage to the air suspension is ruled out.

The monitoring of the wear of the air suspension 1 is refined in that, in addition to reaching the lower level position value 15 and the upper level position value 14, the exceeding (or falling below) of a predetermined average value for a neutral level position 16 is also counted 13. A comparison 23 of the level position 5 detected by the height sensor 10 with the predefined average value for a neutral level 16 is made. The count 13 of the instances of exceeding 27 the neutral level 16 provides additional information for drawing conclusions about the current wear status 17 of the air suspension.

Analogously to the determination of the wear status 17 on the basis of the attainments of the upper level position value 14 and the lower level position value 15 as already described, a count 13 of the events takes place when the value of the detected level position 5 passes the neutral level position 16. The count 13 of the instances of exceeding 27, that is,, the number of times the neutral level 16 is passed, is compared 24 with a predetermined service life value 28. As soon as the count 13 reaches the service life value 28, wear of the air spring 3 is indicated. The monitoring of the passages of the neutral level position 16 is coupled with the monitoring of the instances of level attainment 25 (upper level position and lower level position). In the embodiment example shown, a critical wear status 17 is assumed when cumulatively the counts 11, 12 of the instances of level attainment 25 and the count 13 of the passing of the neutral level position 16 reach the predetermined service life values 20, 28.

It is understood that the foregoing description is that of the preferred embodiments of the invention and that various changes and modifications may be made thereto without departing from the spirit and scope of the invention as defined in the appended claims.

### List of reference signs

1 air suspension

2 wheel

3 air spring

4 bellows

5 level position

6 supply line

7 compressed air source

8 valve block

9 control unit

10 height sensor

11 upper level count

12 lower level count

13 neutral level count

14 upper level value

15 lower level value

16 neutral level

17 wear status

18 comparison of upper level

19 comparison of lower level position

20 service life value

21 comparison of service life value

22 evaluation

23 comparison with neutral level position

24 comparison with service life value

25 instance of level attainment

26 critical wear status

27 instances of exceeding of neutral level

28 service life value

1. A method for monitoring wear of an air suspension for motor vehicles, the method comprising:
continuously detecting a level position of the air suspension via a height sensor, wherein a filling volume of a spring bellows determines the level position of the air suspension;
comparing the level position detected by the height sensor with a predetermined upper level position value for a high level position and a predetermined lower level position value for a low level position;
counting instances of level attainment if the detected level position exceeds the upper level position value or the detected level position falls below the lower level position value; and,
determining a wear status of the air suspension from the count of the instances of level attainment.

2. The method of claim 1 further comprising comparing the count of the instances of level attainment with a predetermined service life value; and, wherein a critical wear status is determined when the service life value or a predetermined proportion thereof is reached.

3. The method of claim 1, wherein the level position detected by the height sensor is compared with a predetermined average value for a neutral level position; instances of exceeding the neutral level position are counted; and, a determination is made from the count of the instances of exceeding the neutral level position as to the wear status of the air suspension.

4. The method of claim 2, wherein the level position detected by the height sensor is compared with a predetermined average value for a neutral level position; instances of exceeding the neutral level position are counted; and, a determination is made from the count of the instances of exceeding the neutral level position as to the wear status of the air suspension.

5. The method of claim 2 further comprising determining progress towards reaching the critical wear status from a comparison of a current count of the instances of level attainment and/or a current count of the instances of exceeding a neutral level position with the service life value or the predetermined proportion.

6. The method of claim 3 further comprising determining progress towards reaching a critical wear status from a comparison of a current count of the instances of level attainment and/or a current count of the instances of exceeding the neutral level position with a service life value or a predetermined proportion of the service life value.
